(19) United States
(12) Patent Application Publication
(10) Pub. No.: US 2008/0316182 A1
(43) Pub. Date: Dec. 25, 2008

(54) Touch Sensor and Method for Operating a Touch Sensor

(76) Inventors: Mika Antila, Pirkkala (FI); Teemu Ramo, Tampere (FI); Marko Karhiniemi, Espoo (FI)

Correspondence Address: WARE FRESSOLA VAN DER SLUYS & ADOLPHSON, LLP, BRADFORD GREEN, BUILDING 5, 755 MAIN STREET, P O BOX 224, MONROE, CT, 06468, US

(21) Appl. No.: 11/766,568

(22) Filed: Jun. 21, 2007

(51) Int. Cl. G06F 3/041

(52) U.S. Cl. 345/173; 178/18.05

(57) ABSTRACT

Touch detection within display devices with a first conductive layer with first and second electrodes, a second conductive layer with third electrodes, a spacer spatially spacing the first conductive layer from the second conductive layer, the first electrodes being arranged for capacitive touch detection, and the second and third electrodes being arranged for resistive touch detection.

### BACKGROUND OF THE INVENTION

1. Technical Field

The present application relates to an apparatus for touch detection, a touch sensor, a touch sensitive display, a multimedia device with a touch sensor as well as a method for operating such an apparatus.

2. Discussion of Related Art

Personal computers and multimedia devices as well as communication devices provide for a user interface (UI) for interacting with a user. The user interface allows the user for operating the device according to his needs. In order to operate the device via the user interface, input means need to be provided. Through these input means, users can input information such as simple operation instructions as well as letter and digits.

One kind of input devices known in the art are touch panels, which are known to be simple, easy to carry, reliable, and capable of inputting simple operating instructions as well as letters and digits. Different kinds of touch panels are known, for example resistive type touch panels, capacitive type touch panels, electro magnetic type touch panels, optical or acoustic type touch panels.

Resistive type touch panels provide for detecting a voltage gradient using an electrode arranged on an upper substrate or a lower substrate of two spaced conductive layers.

Capacitive type touch panels allow for detecting the location of a touch point based on a voltage change created, when an upper substrate having a conducting layer of an equipotential plane is in contact or in proximity with a conductive piece, i.e. a user's finger or a conductive stylus pen.

Electro magnetic type touch panels detect the location of a touch point by measuring induced currents within a coil of electronic stylus pen.

Using capacitive type touch panels is limited to input devices, which are conductive. Stylus pens, which are not conductive, do not allow inputting information into a capacitive type touch panel. Resistive type touch panels usually are intended for usage with a stylus pen, as their resolution is high and operating these with a user's finger might provide for imprecise inputs. Further, resistive type touch panels require higher forces for sensing a point of contact, which reduces the use by fingers and gives advantage to the use by a stylus pen.

### SUMMARY

To provide for an easy-to-use, multi-purpose input device, the application provides for an apparatus with a first conductive layer with first and second electrodes, a second conductive layer with third electrodes, a spacer spatially spacing the first conductive layer from the second conductive layer, the first electrode being arranged at least for capacitive touch detection, and the second and third electrodes being arranged for resistive touch detection.

It has been found that combining capacitive and resistive touch detection increases the use cases of touch sensors. Resistive touch detection provides for support of a pen use, gives a good resolution for the detected point of contact and provides for force recognition. For example, the point of contact can be located with a high spatial resolution. Further, the force by which the first and second conductive layers are pressed together can be approximated. Capacitive touch sensing provides for sensing multi-touch. Further, it is not necessary to come into physical contact with the first conductive layer, as proximity detection is possible. Proximity detection allows for sensing conductive pieces, such as fingers, in the spatial proximity of the first conductive layer, as already the spatial proximity causes a capacitive sensor sensing a change in the electrical potential. Further, as capacitive touch detection requires only little or even no force applied on the first conductive layer, it is possible to “swipe” scroll bars or the like on a user interface with a simple movement of a finger or a hand of a user.

Providing only a first and a second conductive layer provides for the advantage of reduced thickness, cost and complexity compared to known touch sensors. Providing the second electrodes on the first conductive layer and the third electrodes on the second conductive layer may allow for resistive touch sensing with only five wires for connecting the second and third electrodes. When the first conductive layer is pressed onto the second conductive layer, a voltage gradient may be measured by the second electrodes on the first conductive layer. The voltage may already be applied by the third electrodes on the second conductive layer and transferred, upon pressing the layers together, to the first conductive layer and further sensed by the second electrodes.

According to an embodiment, the first electrodes are arranged a opposing positions on the first conductive layer. It has been found that the capacitive touch sensing is best, in case the first conductive layer is applied with an equal potential plane. Therefore, the first electrodes may be arranged at opposing positions on the first conductive layer at not spatially located close to each other.

Arranging the first electrodes at the corners of the first conductive layer provides for a maximum spatial distance between the electrodes. For example, when the first conductive layer has a rectangular shape, the first electrodes may be four electrodes and may be arranged within the four corners of the first conductive layer.

The first conductive layer, as well as the second conductive layer may be plane or curved. In particular for user interfaces with a display, the first and second conductive layers are plane. For example, it may be possible, that the first and second conductive layers are placed in front of a display. The display may be plane and the first and second conductive layers may be plane as well.

The first and second conductive layers are spaced spatially apart by the spacer. The first and second conductive layers together with the spacer may be supported on a supporting plane, for example a glass or resin plate, carrying the stacked first and second conductive layer and the spacer. It may also be possible that spacer dots are arranged between the conductive layers to keep them from contacting without applied force from the outside. These spacer dots may be arranged on the whole surface of the conductive layers.

In order to provide for an equal potential plane on the first conductive layer, the first electrodes may be supplied with an equal potential according to embodiments. The first electrodes may be connected to sensors applying a same potential. Thus, on the first conductive layer, a substantially equal potential may be applied. This substantial equal potential allows for exact measurement of a touch position.

The sensors which are applying a potential to the first electrodes may further be arranged as current sensors according to embodiments. The current sensors allow for sensing current changes within the electrodes. For example, when a finger touches the first conductive layer at a point equidistant to each of the first electrodes, a current through all of the electrodes is equal and thus it may be concluded that the finger touches the first conductive layer at a point equidistant to all of the electrodes. For example, when the current through one of the electrodes is higher than through another one, it may be concluded that the first conductive layer was touched closer to the electrode where the higher current is sensed. By sensing the currents of all electrodes of the first conductive layer, the exact position of touching the first conductive layer may be deduced.

In order to allow resistive touch sensing using the second electrodes with little wiring needs, embodiments provide the second electrodes as only one electrode. The second electrode may be positioned on the first conductive layer and may sense a current induced onto the first conductive layer by the potential of the second conductive layer, when the two conductive layers are brought into physical contact.

In order to avoid interferences between the capacitive touch sensing of the first electrodes and the resistive touch sensing of the second electrode, embodiments provide arranging the second electrode spatially apart from the first electrodes on the first conductive layer. Another possibility to avoid interferences may be to provide for algorithms which discriminate between the signals of resistive touch sensing and capacitive touch sensing. The signals applied onto the layers for the two types of sensing may differ in structure, allowing discriminating these from each other.

Improved measurement of the current induced by the second conductive layer onto the first conductive layer is possible, when the second electrode is arranged on an edge of the first electrode, according to embodiments. Arranging the electrodes on the corners and edges may allow for the spacer to isolate the first and second electrodes from the third electrodes as well as the first conductive layer from the second conductive layer. The spacer may be arranged, such that it is at least spatially located at the positions of the first, second and third electrodes in between the first and second conductive layers.

According to embodiments, the second electrodes connected to a second current sensor are arranged for sensing a voltage applied by the third electrodes on the second conductive layer upon contact between the first and the second conductive layer. The second current sensors may measure a voltage applied from the second conductive layer onto the first conductive layer through the third and second electrodes. On the second conductive layer, the potential applied by the third electrodes has a gradient from at least one of the electrodes to at least another of the electrodes. Thus, equipotential lines, orthogonal to the field lines on the second conductive layer, define planes of equal potential. By these equipotential lines, distances between electrodes of different potential on the second conductive layer may be defined.

In order to provide for an electric field on the second conductive layer, which allows precise position detection, embodiments provide for arranging the third electrodes at opposing positions on the second conductive layer. A second electrode may be comprised of one electrode arranged on an edge of the first conductive layer. For capacitive touch sensing, the at least four electrodes on the first conductive layer need to be connected with sensors resulting in at least four wires. The resistive touch sensing requires the second and third electrodes to be connected to sensors, resulting in additional at least five wires. It may be possible to use the second electrodes for both capacitive and resistive touch detection. Capacitive and resistive touch sensing according to embodiments of the application may require at least nine wires to be connected to sensors.

According to embodiments, the second electrodes may be connected to first current sensors arranged for sensing current changes within the electrodes. The second electrodes may be used for capacitive and resistive touch detection. The second electrodes may be part of the first electrode. The second electrodes may be at least one of the first electrodes.

According to embodiments, the first electrodeor the second electrode or both the first electrode and the second electrode may be connected to sensors arranged for selectively sensing either current changes within the electrodes or a voltage applied by the third electrodes on the second conductive layer upon contact between the first and the second conductive layer. Switching, sequencing or the like between sensing either current changes within the electrodes or a voltage applied by the third electrodes on the second conductive layer upon contact between the first and the second conductive layer allows for using at least the second electrodes for both capacitive and resistive touch sensing.

According to embodiments, the first conductive layer is larger than the second conductive layer, such that the area of capacitive touch sensing overlaps the area of resistive touch sensing. In this case it may be required that the resistive input is wanted only on the display area. Capacitive measurement may still be extended outside the display area to provide additional slider or button functionalities.

In order to allow conductive and resistive measurements throughout the whole surface of the first and second conductive layers, embodiments provide the first and second conductive layers with equal forms.

For resistive position detection, it is necessary to measure the position of a point of contact between the first and second conductive layer. This can, for example, be done by measuring first a position of the point of contact in a first direction, i.e. the x-direction, and subsequently in a second direction, i.e. the y-direction. For this reason, it may be favorable to first supply a first set of third electrodes with a first voltage and a second set of third electrodes with a second voltage, e.g. a mass, ground or common potential. For example, the first set of electrodes of the third electrodes may be arranged in corners at one edge of the second conductive layer and the second set of electrodes may be arranged at the opposing edge of the second conductive layer. Then, equipotential lines, orthogonal to the field lines between the electrodes, define a distance of the point of contact and first set and second set of electrodes. This may allow measuring position in the x-direction. Supplying temporally succeedingly another set of electrodes, being arranged on edges orthogonal to the edges of the first sets of electrodes with the same voltages allows for measuring the point of contact in the y-direction. When switching between the sets of electrodes being arranged on edges in the y-direction and sets of electrodes being arranged in the x-direction in a temporally succeeding order, i.e. at intervals of fractions of a second, i.e. milliseconds, the x and y coordinates of the point of contact may be measured within short time.

In order to allow the field lines running substantially in the x-direction or the y-direction electrodes located at corners of first edges can be supplied with the same voltage, and thereafter, electrodes arranged at second edges orthogonal to the first edges are supplied with the same voltage.

In order to allow operating a user interface with touch sensing, embodiments provide the first and second conductive layers as transparent layers. The transparent layers may be positioned in front of a display, such as a LCD or OLED display, or LED display, or plasma display, or any other display.

The conductive layers have to be such, that they do not short-circuit the electrodes arranged on the layers. Thus, the conductive layers may have a low resistance. Also, it is possible that the conductive layers are totally conductive for capacitive touch sensing. Capacitive touch detection may work with resistances higher than 90 kOhm per square. Also, the layers may have a resistance of between 1-90 kOhm per square. The resistance of the layers may be different from each other. This may be provided, according to embodiments, by Indium-Tin-Oxide (ITO) or Antimony-Tin-Oxide (ATO) or similar materials, from which the first and second conductive layers are made. The conductive layers may be films as well more rigid materials, such as glass, i.e. ITO coated glass.

Capacitive touch sensing requires a conductive piece, for example a finger, to come into close proximity of or in contact with the first conductive layer. For example, the first conductive layer may be arranged on top of the second conductive layer, thus improving capacitive touch sensing.

In order to allow good resistive touch sensing, it is necessary that the first and second conductive layers come into physical contact with each other, when pressure is applied on the layers. In order to allow the first conductive layer to be pressed onto the second conductive layer easily, embodiments provide the first conductive layer as a flexible layer.

In order to avoid the second conductive layer to be displaced relative to the first conductive layer, embodiments provide the second conductive layer as a stable layer. A stable layer may be a layer with a hard surface.

Another aspect of the application is a touch sensitive display panel comprising an apparatus with a first conductive layer with first and second electrodes, a second conductive layer with third electrodes, a spacer spatially spacing the first conductive layer from the second conductive layer, the first electrodes being arranged at least for capacitive touch detection, the second and third electrodes being arranged for resistive touch detection.

A further aspect of the application is a mobile multimedia device comprising a memory, a processor, a display, and an apparatus with a first conductive layer with first and second electrodes, a second conductive layer with third electrodes, a spacer spatially spacing the first conductive layer from the second conductive layer, the first electrodes being arranged at least for capacitive touch detection, the second and third electrodes being arranged for resistive touch detection.

A further aspect of the application is a method comprising applying a first potential onto a first conductive layer comprising first electrodes, applying a second potential onto a second conductive layer comprising third electrodes, providing capacitive touch detection using the first electrodes on the first conductive layer, and providing resistive touch detection using at least second electrodes arranged on the first conductive layer for sensing contact between the first and the second conductive layer.

Capacitive touch sensing provides for good results, when a conductive layer which is used for capacitive touch sensing is provided with an equal potential throughout its surface. Therefore, embodiments provide applying the first conductive layer with an electrostatic potential.

Resistive touch sensing requires measuring the point of contact between the layers in at least two directions. For this reason, embodiments provide applying a changing or pulsating potential onto the second conductive layer. This changing potential may provide field lines, which are subsequently orthogonal to each other. The field lines may first be substantially in a y-direction, and thereafter substantially in an x-direction, orthogonal to the y-direction. Other directions of field line are also within the scope of the application, as long as the direction of field lines allows for determining the coordinates of a point of contact between the conductive layers.

Embodiments provide that the potential applied to the second conductive layer changes the direction of field lines of the electrical field on the second conductive layer, such that first field lines are substantially orthogonal to temporally following second field lines.

For example, when the apparatus is used in a multimedia device, a mobile phone, or the like, the user interface may be deactivated, when the device is not used. Upon sensing a current change due to moving a conductive piece into the proximity of the first conductive layer, the user interface may be activated, according to embodiments. Thus, when the user moves his finger in the proximity of the displayed panel, the user interface may be activated.

Browsing through content displayed on the user interface may only require approximation of the position of the point of contact. Browsing through a user interface may be done using the first conductive layer with capacitive touch sensing only. Even though the position detection is less accurate than with resistive touch detection the capacitive touch sensing does not require any force applied onto the surface, resulting in easy navigation through menus.

Upon actually pressing the first conductive layer onto the second conductive layer, a user might want to select certain content displayed on the user interface. For selecting the content, exact position detection may be necessary in order to avoid wrongful selection. Embodiments provide activating resistive touch detection when the first and the second conductive layers are brought into contact by pressing the layer onto the second conductive layer. Further, by sensing the absolute value of the current through the second electrode on the first conductive layer, it may be determined at which force the two conductive layers are pressed together. The amount of current may be proportional to the size of point of contact. The higher the force pressing the layers together, the lager the point of contact and the larger the current within the second electrode may be.

When the resistive touch detection is activated, capacitive touch detection may be deactivated. For this reason, embodiments provide for switching of the voltage applied to the first conductive layer upon sensing the voltage applied from the second conductive layer onto the first conductive layer, i.e. sensing a current within the second electrode. This current is sensed, when the first conductive layer is brought into contact with the second conductive layer.

It may also be possible that resistive touch detection is activated per default. In this configuration, it may only be checked whether the layers are pressed together and then the apparatus may be fully activated, i.e. the display may be switched on or the like. Resistive touch detection may consume less energy, why it may be chosen as the detection mode upon which the apparatus is activated initially.

Further embodiments provide switching on the voltage applied to the first conductive layer upon sensing zero current from second conductive layer within the second electrode. Zero current is sensed, for example, when the pressure is removed from the first conductive layer, resulting in no further contact between the first conductive layer and the second conductive layer. A user might have selected a certain content and precise position detection is not required anymore. The zero current detection may be coupled to a time lag. Only when the zero current is measured for a certain amount of time, the resistive touch detection may be deactivated and the capacitive touch detection re-activated.

A further aspect of the application is a an apparatus, for example a touch sensor, with first conductive means arranged for forming a first conductive layer with first and second electrodes, second conductive means arranged for forming a second conductive layer with third electrodes, spacer means arranged for spatially spacing the first conductive means from the second conductive means, the first electrodes being arranged at least for capacitive touch detection and the second and third electrodes being arranged for resistive touch detection.

These and other aspects of the application will be apparent from and elucidated with reference to the detailed description presented hereinafter. The features of the present application and of its exemplary embodiments as presented above are understood to be disclosed also in all possible combinations with each other.

### BRIEF DESCRIPTION OF THE FIGURES

In the figures show:

FIG. 1 a side view of a touch sensor according to embodiments;

FIG. 2 a sectional view of a display panel with a touch sensor according to embodiments;

FIG. 3 a block diagram of a circuit for feeding a touch sensor with signals according to embodiments;

FIG. 4a an illustration of field lines on a conductive layer according to embodiments;

FIG. 4b an illustration of field lines of a conductive layer according to embodiments;

FIG. 5 a top view of a mobile multimedia device;

FIG. 6 a first flowchart of a method according to embodiments;

FIG. 7 a second flowchart of a method according to embodiments;

FIG. 8 a third flowchart of a method according to embodiments.

### DETAILED DESCRIPTION OF THE INVENTION

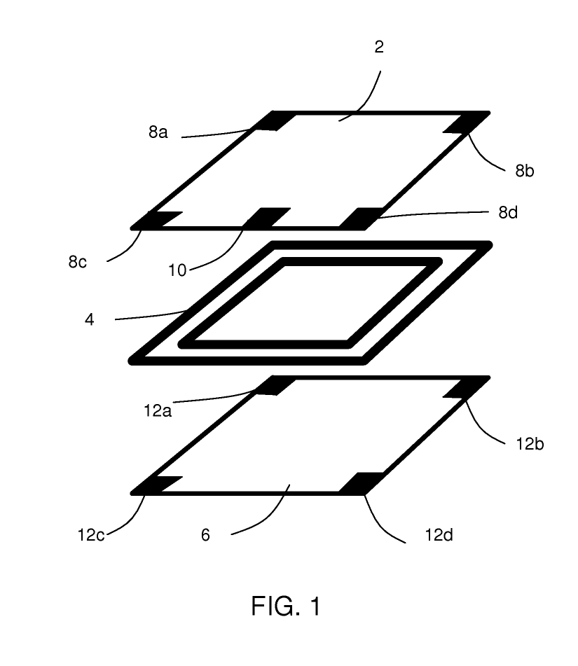

FIG. 1 illustrates a first conductive layer 2, a spacer 4, and a second conductive layer 6. The first conductive layer 2 may be made of a flexible material. The first conductive layer 2 may be made of Indium-Tin-Oxide. The first conductive layer 2 may be arranged as a flexible matrix. The second conductive layer 6 may be made of a stable material. The second conductive layer 6 may be made of Indium-Tin-Oxide. The second conductive layer 6 may be arranged on a stable substrate or within a stable matrix. The spacer 4 may be made of an insulating material. The first conductive layer 2 may be positioned above spacer 4 and spacer 4 may be positioned above second conductive layer 6. The illustration is an exploded view of an apparatus according to embodiments.

For operating the touch sensor, the first conductive layer 2, the spacer 4, and the second conductive layer 6 are stacked on top of each other building a monolithic structure.

First conductive layer 2 has on its corners four first electrodes 8, and on an edge, spatially located apart from the corners of the first conductive layer 2 second electrodes 10. First electrodes 8 and second electrodes 10 may be arranged such that they are capable of applying a voltage and a current onto the first conductive layer as well as sensing a current and a voltage on the first conductive layer 2.

In the area of the first electrodes 8 and the second electrodes 10, the spacer 4 may be arranged. The spacer 4 may be ring-shaped thus forming a carrier around all edges of the second conductive layer 2. The spacer 4 may, however, also be shaped to be only positioned in the area of the first electrodes 8 and the second electrodes 10.

The second conductive layer 6 may be arranged, such that third electrodes 12 are arranged within its corners. The third electrodes 12 allow applying a voltage and a current onto second conductive layer 6 as well as sensing a current within second conductive layer 6.

The first conductive layer 2 may be, as explained above, formed of a flexible material. A user may depress first conductive layer 2 with its finger or a stylus pen such that it comes into contact with second conductive layer 6. A point of contact between first conductive layer and second conductive layer needs to be evaluated for a touch sensor, as will be described hereinafter.

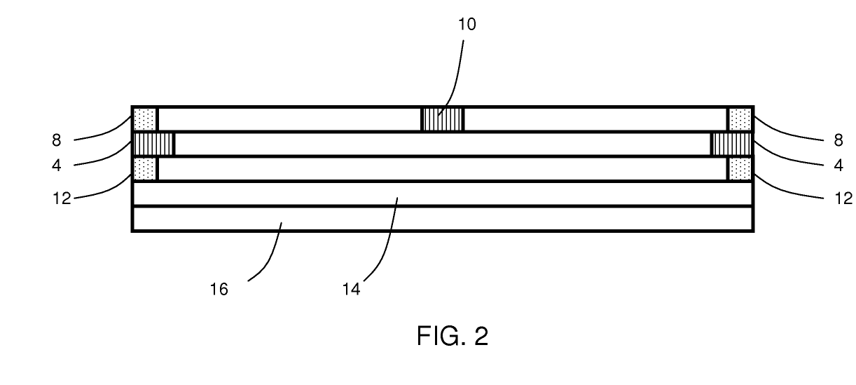

FIG. 2 illustrates a sectional view of a display with a touch sensor in simplified form. As can be seen, first conductive layer 2 with first electrodes 8, and third electrodes 10 is positioned above spacer 4. Spacer 4 provides for a spatial distance between the lower surface of first conductive layer 2 and the upper surface of second conductive layer 6. Below second conductive layer 6, a supporting substrate 14, for example glass, may be positioned, for supporting the second conductive layer 6. Below the supporting substrate 14, a display device 16 may be arranged. As first conductive layer 2, and second conductive layer 6, as well as the supporting substrate 14 may be transparent, an image displayed on display device 16 may be seen through the layers 2, 4, 14.

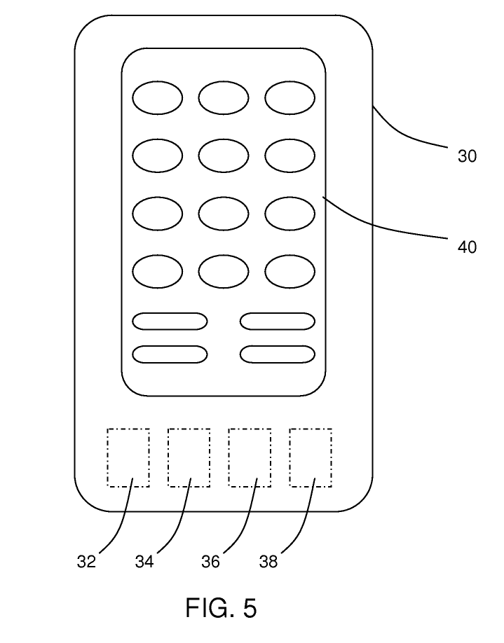

In operation, the display device 16 may illustrate a user interface, as will be seen in FIG. 5.

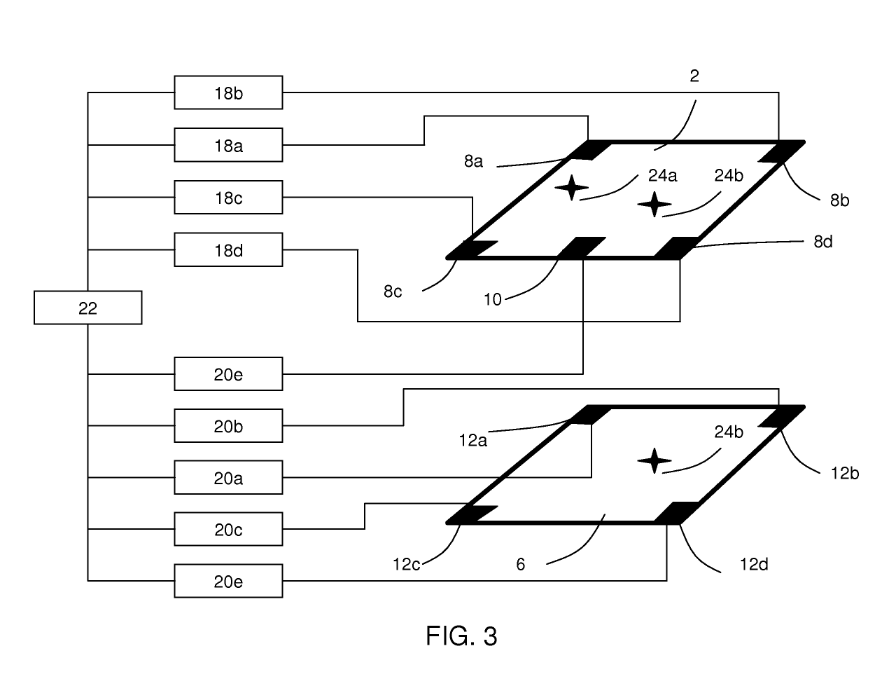

The first conductive layer 2 may be used for capacitive touch detection using the first electrodes 8. The first conductive layer 2 together with the second conductive layer 6 may be used for resistive touch detection using the second electrodes 10 and the third electrodes 12. For combined capacitive and resistive touch detection, the first electrodes 8 need to be connected by four wires, and the second electrodes 10 and the third electrodes 12 need to be connected by five additional wires with appropriate measurement units, i.e. means for sensing currents and/or voltages with drivers for applying currents and/or voltages. Thus, overall nine wires allow for capacitive and resistive touch detection. For capacitive and resistive touch detection, the electrodes 8, 10, 12 need to be fed with appropriate signals, as will be explained in conjunction with FIG. 3.

FIG. 3 illustrates schematically the wiring of first conductive layer 2 and second conductive layer 6. As illustrated, first conductive layer 2 comprises the first electrodes 8. First electrodes 8 are connected to drivers 18 for sensing currents and applying potentials to the electrodes 8 through four wires. Further, the second electrode 10 on the first conductive layer 2 is connected to a driver 20e for sensing currents and applying potentials through electrode 10.

As second electrode 10 is used for resistive touch detection, it needs to be operated in close cooperation with third electrodes 12, which are connected to drivers 20a-d for sensing currents and applying potentials through electrodes 20a-d.

Drivers 18 as well as drivers 20 are operated by a signal processor such as a microprocessor 22 for feeding currents to the electrodes 8, 10, 12 as well as for reading out the drivers of the drivers 18, 20. Drivers 18, 20 may be understood as electronic or electric circuits for applying a voltage onto electrodes and for sensing voltages and currents within the electrodes. Drivers 18, 20 may comprise voltage sources, current sources, current sensors and/or voltage sensors. Drivers 18, 20 may electrically determine voltages and currents within connected electrodes.

For capacitive touch detection, the drivers 18 apply an equal potential onto the electrodes 8. By applying an equal potential to the electrodes 8, first conductive layer 2 is electrostatically charged at a certain potential.

When approaching first conductive layer with a conductive piece, such as a finger or a conductive stylus pen, charges are drawn up by the conductive piece and thus inducing a current on first conductive layer 2. This current may be sensed by drivers 18. When touching the first conductive layer, a current flows from the electrodes 8 through the conductive piece to mass-potential. Depending on the position, where the first conductive layer is touched or a conductive piece is in the proximity of the first conductive layer 2, the current through the electrodes 8 differs. The closer the point of contact between the conductive piece and an electrode 8 is, the higher the current through this particular electrode 8. By sensing the currents through electrodes 8a-d, and differentiating between the currents within drivers 18, it is possible to evaluate by microprocessor 22, where the position of contact between the conductive piece, and the first conductive layer 2 is.

For example, when the first conductive layer 2 is touched at a position 24a, the current through electrode 8a is highest. The next lower current is the current through electrode 8c followed by the current through electrode 8b and, as electrode 8c is farthest away from the position 24a, the current through electrode 8d is lowest. By evaluating the currents through the electrodes 8 sensed by the drivers 18 in microprocessor 22, it may be deduced, where position 24a is. The first conductive layer 2 is, as illustrated above, capable of capacitive touch detection. It is possible, to detect a conductive piece in the proximity of the first conductive layer 2, as well as a position 24a of point of contact.

For resistive touch detection, it is necessary, that first conductive layer 2 and second conductive layer 6 come into contact with each other. This contact may be established by pressing the first conductive layer 2 onto the second conductive layer 6, for example using a stylus pen or a finger. By bringing the first conductive layer 2 into physical contact with second conductive layer 6, it is possible to measure a current in second electrode 10, applied by third electrodes 12 onto the second conductive layer 6, as will be explained hereinafter.

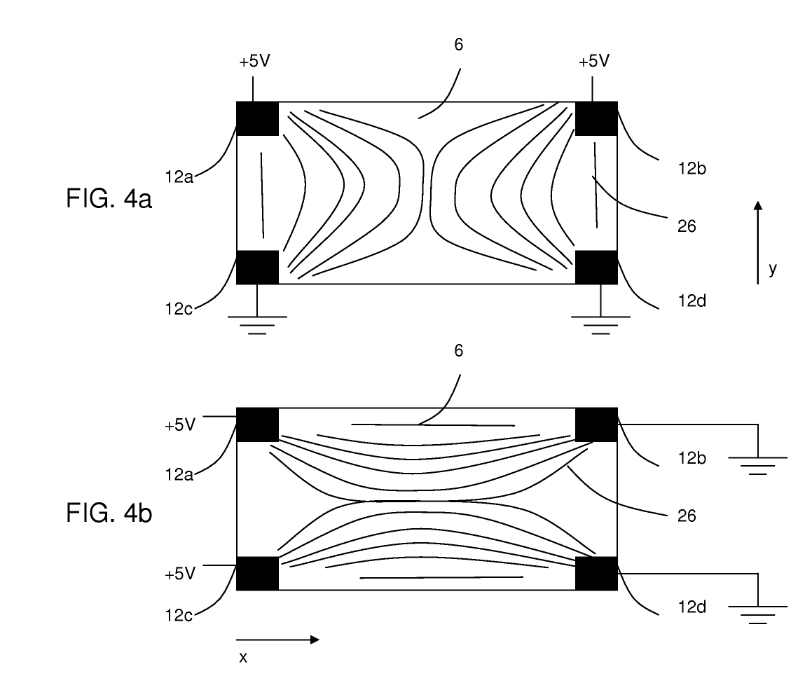

For resistive touch detection, it is necessary, to detect the coordinates of position 24b of a point of a contact between the conductive layers 2, 6, with respect to the y-direction and x-direction. For this reason, as illustrated in FIG. 4, voltages are applied to the electrodes 12, such that field lines are subsequently substantially orthogonal to each other.

As can bee seen in FIG. 4a, electrodes 12a, 12b are supplied by drivers 20a, 20b with +5V potential and electrodes 12c, d are supplied with mass potential by drivers 20c, 20d. Field lines 26 are illustrated which are established between the third electrodes 12a, 12b and the third electrodes 12c, 12d. Along the field lines, a voltage gradient is established, moving from +5V to mass potential. Equipotential lines (not illustrated) are orthogonal to the field lines 26 defining positions of equal potential.

When measuring a position 24b, third electrodes 12 are supplied with a voltage as illustrated in FIG. 4a. At the position 24b, a voltage has a certain value defining an equipotential line along the y-direction. When sensing with the second electrode 10 and a high input resistance A/D converter, only low currents flow from the second to the first conductive layers 2, 6 through the point of contact. The voltage measured on the first conductive layer 2 using second electrode 10 may be the voltage at the point of contact. This voltage in the point of contact between the first conductive layer 2 and the second conductive layer 6 at position 24b allows determining the y-position of position 26. The voltage is higher or lower, i.e. whether the position 26 is closer or further away from third electrodes 12a, 12b in the y-direction.

Subsequent to supplying a voltage according to FIG. 4a, microprocessor 22 instructs drivers 20 to apply a voltage onto the third electrodes 12 as illustrated in FIG. 4b. The +5V potential is switched from third electrodes 12a, 12b to third electrodes 12a, 12c. The mass-potential is switched from third electrodes 12c, 12d to third electrodes 12b, 12d. Again illustrated are field lines 26, which path is from electrodes 12a, 12c to electrodes 12b, 12d. Orthogonal to the field lines 26 are equipotential lines (not illustrated), defining planes of equal potential. At the point of contact at position 24b, a well defined potential in the x-direction is established. At the point of contact at position 24b, a voltage may be sensed in second electrode 10 through driver 20e. It is possible to measure a position 24b of the point of contact in x-direction.

By subsequently switching between applying the voltage according to FIG. 4a and FIG. 4b in short intervals, for example within milliseconds, it is possible, to quickly determine the position 24b of a point of contact in both x- and y-direction. Thus, it is possible, to provide resistive touch detection.

When measuring an absolute value of a current within electrode 10, it may also be possible to determine a strength of a force pushing conductive layers 2, 6 together. It has been found, that the value of the current may be substantially proportional to the size of the area of contact. The higher the pressure, the bigger the area of contact is. A bigger area of contact results in a higher current. The driver 20e may measure the value of the current. From this value, the microprocessor may determine the force by which the layers 2, 6 are pressed together. This allows force sensing with resistive touch detection.

FIG. 5 illustrates a mobile phone 30 having a memory 32, a CPU 34, a display driver 36, as well as a communication unit 38. Further, the mobile phone 30 comprises a display 40, which may comprise a protection layer, for example a transparent resin. The display comprises first conductive layer 2, spacer 4, second conductive layer 6, glass substrate 14, as well as display device 16. With display 40 it is possible to show a user interface to a user of the mobile phone 30. For example, the user interface may show digits and buttons for dialing a certain number. Other user interfaces, for example for showing an MP3 play list, for browsing through menus, for internet browsing, address book browsing, calendar browsing, messaging services and the like may be displayed on display 40. The user may operate the display 40 by touching the display at positions of buttons or sliders. By touching display 40, CPU 34 may receive information about the usage of the mobile phone 30 and operate the mobile phone 30 accordingly. Display driver 36 may supply user interfaces to display 40 depending on the operation of the user. From memory 32, the user interfaces may be loaded and displayed on display 40. Upon selecting setting up a phone call, or setting up other communication links, CPU 34 may instruct communication unit 38 to establish such a connection.

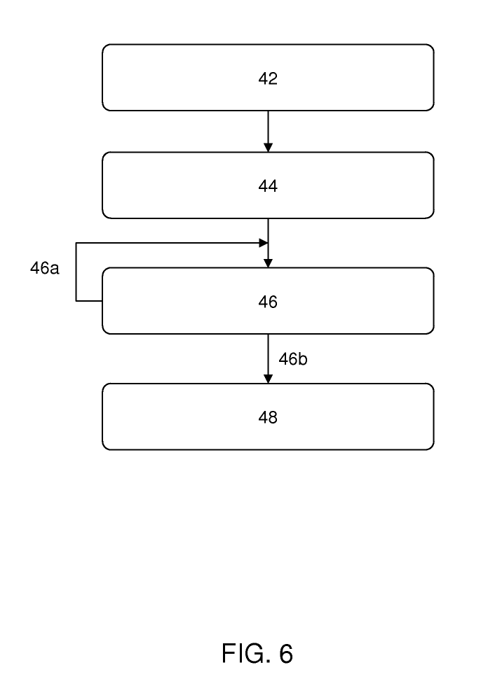

The operation of a mobile phone 30 as illustrated in FIG. 5 is shown in FIGS. 6-8.

Display driver 36 drives display 40 such that the first conductive layer 2 is provided 42 with a static potential, as described in conjunction with FIG. 3. Further, second conductive layer 6 is provided 44 with a pulsating potential being switched between the electrodes 12, as described in FIGS. 3 and 4.

Then it is sensed 46 if the first conductive layer 2 is pressed onto second conductive layer 6. Depending on the force the first conductive layer 2 is pressed onto a second conductive layer 6, the point of contact grows in its size and the current in second electrode 10 increases. If the force by which the layers 2, 6 are pressed together, i.e. the sensed current in electrode 10, is below a certain threshold 46a, the sensing 46 is continued.

Else, if the current increase above a certain threshold level 46b, the user interface is activated 48. By this, it is possible, to use force sensing to activate the user interface. When the display 40 is only gently touched, the force is not sufficient to let the current through second electrode 10 grow above the threshold level.

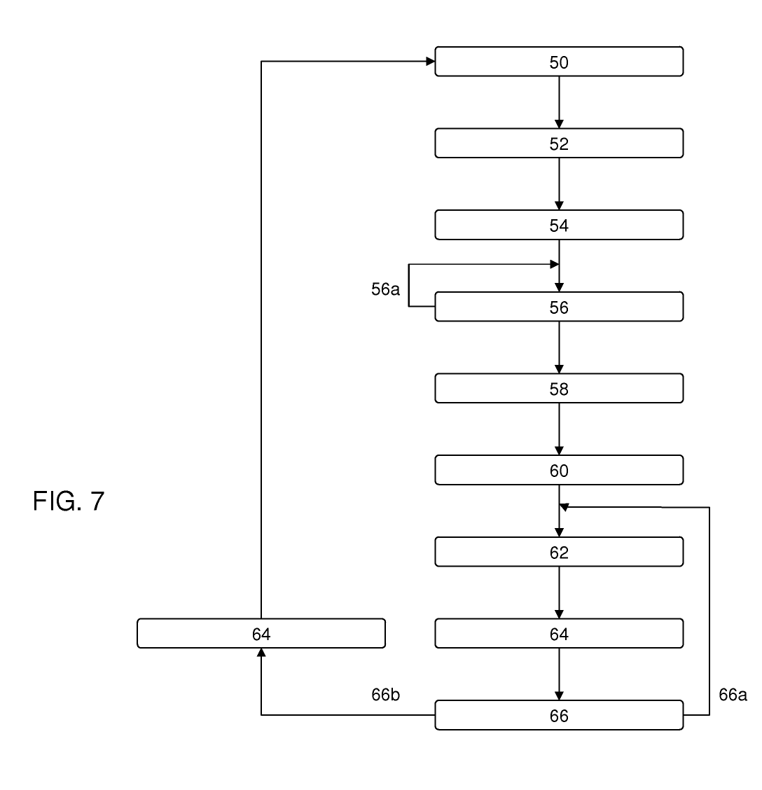

FIG. 7 illustrates a method according to a further embodiment.

After providing 42, 44 static and pulsating potential the first conductive layer 2 is used for capacitive touch detection. It is measured 50, whether a conductive piece approaches the first conductive layer 2, thus incurring a current through electrodes 8. If a conductive piece is detected in the proximity of the layer 2, the user interface provided by display driver 46 on display 40 is optimized for finger use. For example, using the finger is not as accurate as using a stylus pen. Touch buttons may be increased in size. Further, it may be possible to show slide bars, for sliding through an MP3 list or other content. After optimizing 52 the user interface for capacitive touch detection, the user interface may be operated 54 with finger input.

While the user interface is operated according to finger use, it is constantly sensed 56, whether pressure is applied onto the display 40, by measuring the current in second electrode 10. If the current in second electrode 10 is below 56a a certain threshold, the user interface stays in its state. Else, if the sensed pressure 56 is above 56b a certain threshold, i.e. the size of point of contact between the first conductive layer 2 and the second conductive layer 6 is increased by increased pressure and thus the current through electrodes 10 is increased, the resistive touch detection is activated 58.

Upon resistive touch detection, the user interface is optimized 60 for touch detection by display driver 36. This may be the case, when the user switches from finger operation to stylus operation. A stylus pen allows more precise selecting certain buttons and content within display 40, thus, the user interface may be smaller and comprised more selectable items.

Further to optimizing 60 the user interface for resistive touch detection, the capacitive touch detection is turned off 62. This prevents the capacitive touch detection from interfering with the resistive touch detection.

During resistive touch detection, the position 24b is sensed 64 continuously, as described in conjunction with FIG. 3 and FIG. 4.

While in resistive touch detection mode, it is continuously sensed 66, whether the first conductive layer 2 is still in contact with the second conductive layer 6. If the first conductive layer 2 is disconnected for only a short time 66a, it is assumed that the resistive touch detection mode may still be kept operative. When the time of disconnecting the first conductive layer 2 from the second conductive layer 6 increases above a certain threshold 66b, it is determined that resistive touch detection mode shall deactivated.

The resistive touch detection is switched off 68, the capacitive touch detection is turned on again and it is again sensed 50, whether a conductive piece comes in the proximity of the first conductive layer 2.

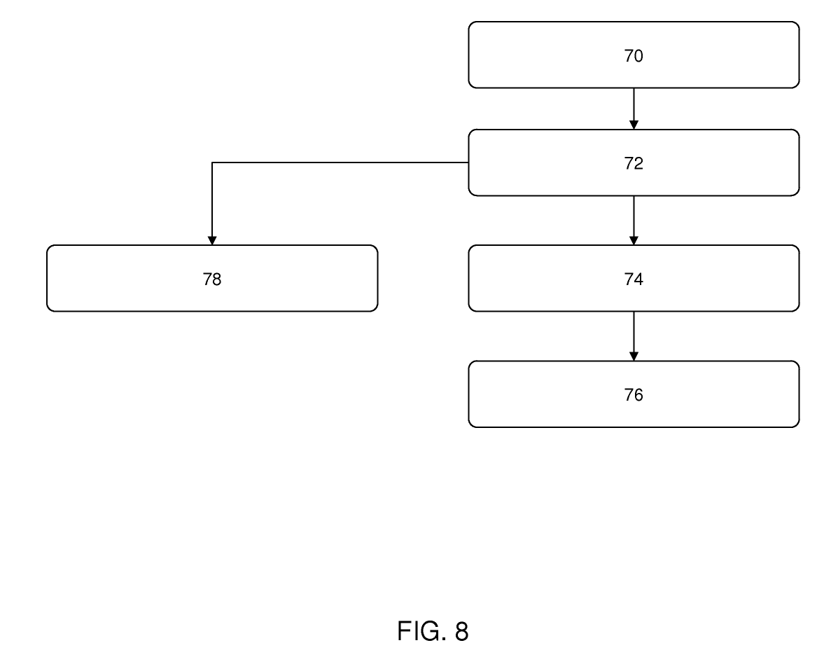

FIG. 8 illustrates a further operation according to embodiments. When a phone call is received 70 in mobile phone 30 by communication unit 38, it is sensed 70, whether the user just swipes its hand over the display 40 or touches the display 40. When the user swipes his hand over display 40, the capacitive touch detection senses a conductive piece in proximity of conductive layer 2, which may be interpreted as rejecting a call 78. Else, if the user actively presses onto first conductive layer 2 bringing it into contact with second conductive layer 6, resistive touch detection is activated. It may be interpreted as answering the phone 74. When answering the phone 74, it is assumed that the user moves the phone 30 to its ear. For this reason, the capacitive touch detection is deactivated 76 in order to prevent the user from selecting certain items on the user interface unintentionally with his ear.

Further operation methods are possible and within the subject matter of the application. By combining capacitive and resistive touch detection with only one additional wire, it is possible to increase the use cases with only little changes to the drivers 18, 20. The touch detection according to the embodiments is more durable than known touch detections. Further, the touch detection may be operated using standard controllers, as well as dedicated ASICs. It is further possible to detect, whether the display 40 is touched with a finger or a stylus pen, as when the finger touches the display, the capacitive touch detection detects a conductive piece in its proximity, whereas when a stylus touches the surface of the display 40, capacitive measurement does not detect it. Thus, pen and finger use can be easily distinguished from each other. The apparatus and methods according to embodiments increases the usability of touch sensors.

The invention has been described above by means of exemplary embodiments. It should be noted that there are alternative ways and variations which are obvious to a skilled person in the art and can be implemented without deviating from the scope and spirit of the appended claims.

Furthermore, it is readily clear for a skilled person that the logical blocks in the schematic block diagrams as well as the flowchart and algorithm steps presented in the above description may at least partially be implemented in electronic hardware and/or computer software, wherein it depends on the functionality of the logical block, flowchart step and algorithm step and on design constraints imposed on the respective devices to which degree a logical block, a flowchart step or algorithm step is implemented in hardware or software. The presented logical blocks, flowchart steps and algorithm steps may for instance be implemented in one or more digital signal processors, application specific integrated circuits, field programmable gate arrays or other programmable devices. The computer software may be stored in a variety of storage media of electric, magnetic, electro-magnetic or optic type and may be read and executed by a processor, such as for instance a microprocessor. To this end, the processor and the storage medium may be coupled to interchange information, or the storage medium may be included in the processor.

What is claimed is:

1. An apparatus with
a first conductive layer with first and second electrodes,
a second conductive layer with third electrodes,
a spacer spatially spacing the first conductive layer from the second conductive layer,
the first electrodes being arranged at least for capacitive touch detection,
the second and third electrodes being arranged for resistive touch detection.

2. The apparatus of claim 1, wherein the first electrodes are arranged at opposing positions on the first conductive layer.

3. The apparatus of claim 2, wherein the first electrodes are arranged at the corners of the first conductive layer.

4. The apparatus of claim 1, wherein the first conductive layer is curved or plane.

5. The apparatus of claim 1, wherein the first electrodes are supplied with an equal potential.

6. The apparatus of claim 1, wherein the first electrodes are connected to first current sensors arranged for sensing current changes within the electrodes.

7. The apparatus of claim 1, wherein the second electrodes are connected to first current sensors arranged for sensing current changes within the electrodes.

8. The apparatus of claim 7, wherein the first and/or the second electrodes are connected to sensors arranged for selectively sensing either current changes within the electrodes or a voltage applied by the third electrodes on the second conductive layer upon contact between the first and the second conductive layer.

9. The apparatus of claim 1, wherein the second electrodes are one electrode.

10. The apparatus of claim 1, wherein the second electrodes are arranged spatially apart from the first electrodes on the first conductive layer.

11. The apparatus of claim 1, wherein the second electrode is arranged on an edge of the first conductive layer.

12. The apparatus of claim 1, wherein the second electrode connected to a second current sensor arranged for sensing a voltage applied by the third electrodes on the second conductive layer upon contact between the first and the second conductive layer.

13. The apparatus of claim 1, wherein the third electrodes are arranged at opposing positions on the second conductive layer.

14. The apparatus of claim 1, wherein the third electrodes are arranged at the corners of the second conductive layer.

15. The apparatus of claim 1, wherein the first conductive layer is larger than the second conductive layer, such that the area of capacitive touch sensing overlaps the area of resistive touch sensing.

16. The apparatus of claim 1, wherein the second conductive layer is formed equal to the first conductive layer.

17. The apparatus of claim 1, wherein the third electrodes are connected to a switching unit such that field lines of the electrical field on the second conducive layer are successively substantially orthogonal to each other.

18. The apparatus of claim 1, wherein the third electrodes are connected to a switch such that successively sets of the third electrodes are at an equal potential.

19. The apparatus of claim 1, wherein the third electrodes are connected to a switch such that a first set of the third electrodes is at a first potential and a second set of the third electrodes is at a second potential.

20. The apparatus of claim 1, wherein the first and the second conductive layers are transparent.

21. The apparatus of claim 1, wherein the first and the second conductive layers are made of at least one of:
A) Indium-Tin-Oxide,
B) Antimony-Tin-Oxide,
C) PEDOT,
D) Orgacon,
E) conductive organic materials,
F) conductive inks,
G) carbon nanotube coatings,
H) conductive plastics,
I) conductive paints,
J) metal meshes

22. The apparatus of claim 1, wherein the first conductive layer is arranged on top of the second conductive layer.

23. The apparatus of claim 1, wherein the first conductive layer and/or the second conductive layer is a flexible layer.

24. The apparatus of claim 1, wherein the second conductive layer is a stable layer.

25. A touch sensitive display panel comprising a apparatus of claim 1.

26. A mobile multimedia device comprising a memory, a processor, a display and a apparatus of claim 1.

27. A method comprising:
applying a first potential onto a first conductive layer comprising first electrodes,
applying a second potential onto a second conductive layer comprising third electrodes,
providing capacitive touch detection using the first electrodes on the first conductive layer, and
providing resistive touch detection using at least second electrodes arranged on the first conductive layer for sensing contact between the first and the second conductive layer.

28. The method of claim 27, wherein the first conductive layer is applied with an electro static potential.

29. The method of claim 27, wherein the second conductive layer is applied with a temporally changing potential.

30. The method of claim 27, wherein the potential applied to the second conductive layer temporally changes the direction of field lines of the electrical field such that first field lines are substantially orthogonal temporally following second field lines.

31. The method of claim 27, wherein sensing a conductive piece in the proximity of the first conductive layer due to a current change activates a user interface of a display panel.

32. The method of claim 27, wherein the first conductive layer provides for browsing through a user interface.

33. The method of claim 27, wherein sensing the first and the second conductive layers being in contact activates a user interface of a display panel.

34. The method of claim 27, wherein when the first and the second conductive layers are brought into contact by pressing the first conductive layer onto the second conductive layer, resistive touch detection is activated.

35. The method of claim 27, wherein in an idle mode of the user interface only resistive touch detection is activated

36. The method of claim 27, wherein the voltage applied to the first conductive layer is switched off upon sensing the voltage applied from the second conductive layer onto the first conductive layer.

37. The method of claim 27, wherein the voltage applied to the first conductive layer is switched on upon sensing that no voltage is applied from the second conductive layer onto the first conductive layer.

38. An apparatus with
first conductive means arranged for forming a first conductive layer with first and second electrodes,
second conductive means arranged for forming a second conductive layer with third electrodes,
spacer means arranged for spatially spacing the first conductive means from the second conductive means,
the first electrodes being arranged at least for capacitive touch detection, and
the second and third electrodes being arranged for resistive touch detection.
